(19) United States
(12) Patent Application Publication
(10) Pub. No.: US 2022/0286554 A1
(43) Pub. Date: Sep. 8, 2022

(54) SYSTEM AND METHOD FOR ESTABLISHING ONE-TO-ONE VOICE CALL BETWEEN TWO SELECTED SMARTPHONES

(71) Applicant: Peigen Jiang, Sammamish, WA (US)

(72) Inventor: Peigen Jiang, Sammamish, WA (US)

(73) Assignee: Peigen Jiang, Sammamish, WA (US)

(21) Appl. No.: 17/194,271

(22) Filed: Mar. 7, 2021

(51) Int. Cl. H04M 3/436; H04M 1/72472; H04M 3/42; H04W 68/00; H04W 4/16

(52) U.S. Cl. CPC H04M 3/4365; H04M 1/72472; H04M 3/42008; H04W 68/005; H04W 4/16; H04M 2250/58

(57) ABSTRACT

A system and method for establishing a one-to-one voice call between two selected smartphones are disclosed which include the sequential steps of receiving predetermined preference data and an indication of ready for internet telephony call by a data storage device from a first smartphone, retrieving from the data storage device a list of smartphones each having the same predetermined preference data and being ready for internet telephony call, the list of smartphones including feature data of a second smartphone, displaying the list of smartphones on the first smartphone, alerting a request for an internet telephony call on the second smartphone when the second smartphone is selected on the first smartphone, and establishing an internet telephony call between the first and the second smartphone when the request is accepted on the second smartphone.

### BACKGROUND

The present disclosure relates generally to the field of internet telephony, and, more particularly, to a system and method for establishing one-to-one voice communication between two selected smartphones.

According to Aristotle, human beings are “social animals” and therefore naturally seek the companionship of others as part of their well being. People need to talk to each other—even between totally strangers. Ham radio serves such a need. However, ham radio service requires sophisticated radio equipment and a government license to a small radio spectrum, thus its adoption has been limited.

On the other hand, smartphones which can access the Internet and make internet telephony calls, have been widely adopted at this time. As such, a technical problem the present disclosure is trying to solve is how to facilitate people using smartphones to talk to each other like ham radio does.

### SUMMARY

A system and method for establishing a one-to-one voice call between two selected smartphones are disclosed which include the sequential steps of receiving predetermined preference data and an indication of ready for internet telephony call by a data storage device from a first smartphone, retrieving from the data storage device a list of smartphones each having the same predetermined preference data and being ready for internet telephony call, the list of smartphones including feature data of a second smartphone, displaying the list of smartphones on the first smartphone, alerting a request for an internet telephony call on the second smartphone when the second smartphone is selected on the first smartphone, and establishing an internet telephony call between the first and the second smartphone when the request is accepted on the second smartphone.

### BRIEF DESCRIPTION OF THE DRAWING

FIG. 1 is a flow-chart illustrating a process for establishing a one-to-one voice call between two selected smartphones according to an embodiment of the present disclosure.

FIG. 2 illustrate a user interface of a smartphone requesting connection with others.

FIG. 3 illustrates a user interface of a smartphone displaying a list of available users to connect to.

FIGS. 4A and 4B illustrates user interfaces of two connecting smartphones.

FIG. 5 illustrates a user interface after a smartphone is connected with another smartphone.

FIG. 6 illustrates a user interface of a smartphone after a connection is ended.

FIG. 7 is a block diagram of a data storage device associated with the communication application of the present disclosure.

The drawings accompanying and forming part of this specification are included to depict certain aspects of the disclosure. A clearer conception of the disclosure, and of the components and operation of systems provided with the disclosure, will become more readily apparent by referring to the exemplary, and therefore non-limiting, embodiments illustrated in the drawings, wherein like reference numbers (if they occur in more than one view) designate the same elements. The disclosure may be better understood by reference to one or more of these drawings in combination with the description presented herein.

### DESCRIPTION

The present disclosure relates to a system and method for establishing one-to-one voice communication between two selected smartphones. A preferred embodiment of the present disclosure will be described hereinafter with reference to the attached drawings.

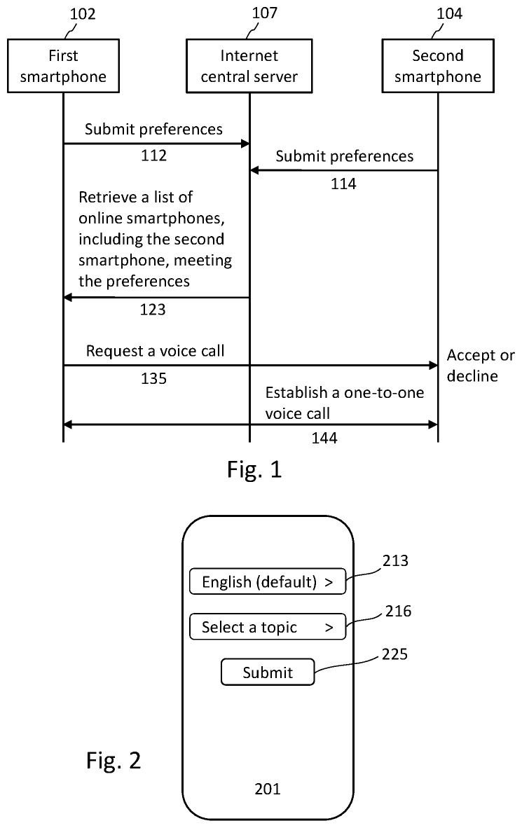

FIG. 1 is a flow-chart illustrating a process for establishing a one-to-one voice call between two selected smartphones 102 and 104 according to an embodiment of the present disclosure. The smartphones 102 and 104 as many other smartphones can run a locally installed communication application that can access a central server 107 over the Internet. The communication application in operation provides such one-to-one voice call. In embodiments, both the smartphone 102 and 104 may have to pre-register with the communication application by entering respective feature and preference data. Feature data exemplarily include name, age, and phone number. Preference data exemplarily include a language used in the voice call and a topic of interest. After a log-in, the first smartphone 102 submits its user preferences to the communication application to be stored in the Internet server 107 in step 112 as shown in FIG. 1. Similarly, the smartphone 104 may also submit its user preferences to the communication application to be stored in the Internet server 107 in step 114. In this case, the first smartphone 102 and the second smartphone 104 have overlapping user preferences, such as a language preference and a topic of interest.

In step 123, the communication application installed in the smartphone 123 retrieves a list of currently online smartphones from the Internet central server 107. The list includes the exemplary second smartphone 104 that have the overlapping user preferences as the first smartphone. In step 135, a user of the first smartphone 102 selects the second smartphone 104 from the list and enact the communication application to send a voice call request to the second smartphone 104. Upon receiving the request, a user of the second smartphone 104 can either accept or decline the voice call request. Once the second smartphone 104 accepts the request, a one-to-one voice call is then established between the first and the second smartphones 102 and 104 by the communication application installed in both smartphones 102 and 104. In embodiments, the voice call is an anonymous Voice-over-IP (VoIP) telephony call, i.e., the first smartphone 102's phone number is invisible to the second smartphone, and vice versa.

FIG. 2 illustrate a user interface of a smartphone requesting voice call with others. The user interface includes a display screen 201 exemplarily displaying two selection boxes 213 and 216 and a submit button 225. The selection box 213 allows a user to select a language from a list of languages. The selection box 225 allows the user to select a topic of interest from a list of topics. Alternatively, the user can enter a topic by typing. Once the submit button 225 is pressed, the selections as preference data will be transmitted by the communication application installed in the smartphone to the Internet server 107 which will store the selections and an identification of the corresponding smartphone in a database. The entries in the database represents all the pre-registered smartphones that are currently online and ready to be connected with another smartphone.

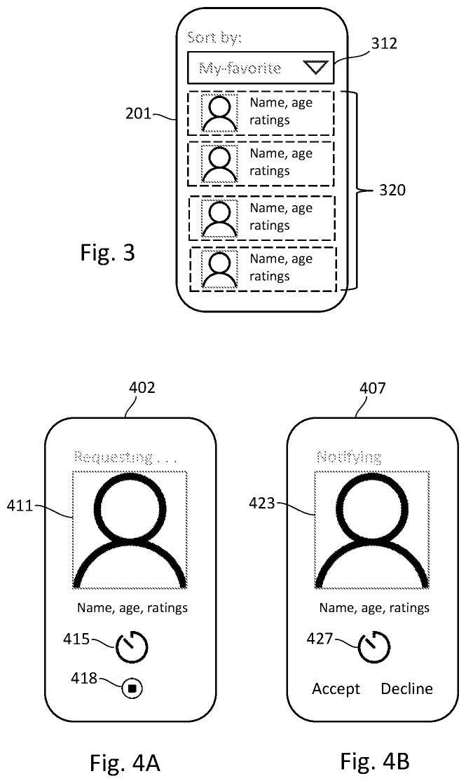

FIG. 3 illustrates a user interface of a smartphone displaying a list of available users to connect to. After a particular smartphone submits preferences to the communication application and become online, the communication application retrieves a list of other smartphones 320 that are also online and ready to connect to. The communication application selects the smartphones 320 based on the particular smartphone's preferences such as language and topic of interests, i.e., the particular smartphone can only connect to another smartphone with the same preferences.

As shown in FIG. 3, the other smartphones 320 may exemplarily represented by a picture, name, age and ratings of its user. That information may help the user of this particular smartphone to select a desired smartphone to connect to. In an embodiment, the user interface includes a selection box 312 allowing the user to sort through the list of other smartphones 320 based on a selected criterion, such as only displaying my-favorite users, within a certain age or above a certain rating. Once the user tap a smartphone 320, a voice call request will be generated by the communication application which in turn push a notification of the voice call request to the smartphone 320.

FIGS. 4A and 4B illustrates user interfaces of two connecting smartphones. Referring to FIG. 4A, on a display screen of a requesting smartphone 402, a requested user's picture 411 is optionally displayed along with his or her name, age and ratings. A timer 415 may also be displayed. If the request is not accepted within a certain time, for instance 10 seconds, the request will automatically expire, and the display screen will automatically return to the screen shown in FIG. 3.

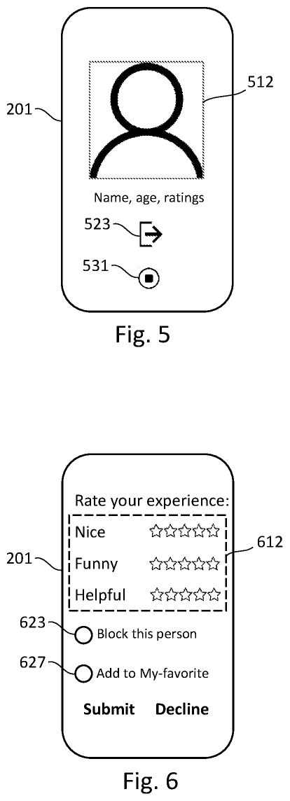

Referring to FIG. 4B, on a display screen of a requested smartphone 407, a requesting user's picture 423 is optionally displayed along with his or her name, age and ratings. A timer 427 displays how many seconds left for the user to either accept or decline the request. If the timer 427 reaches a predetermined limit before a selection is made, the request automatically expires, and the display screen will automatically return to the screen shown in FIG. 3. Before the time out, the user can press either a “accept” button to accept the voice call request, or a “decline” button to decline the voice call request. After the acceptance, the user interface will change to one shown in FIG. 5. After the decline, the user interface will return to the one shown in FIG. 3.

FIG. 5 illustrates a user interface after a smartphone is connected to another smartphone. On the display screen 201, the other party's information 512 is shown which exemplarily includes a picture, name, age and ratings. A warning button 523 is also shown. When the user intends to politely end the connection of voice call, he or she can press the warning button 523 to send a message informing an intend of ending the voice call to the other party. Alternatively, the user can press a stop button 531 to end the connection immediately.

FIG. 6 illustrates a feedback screen of a smartphone after a connection of voice call is ended. After the connection is ended, the communication application installed in the smartphone displays a feedback screen for a user to rate his or her experience with the communication session. Specifically, the user can enter ratings of niceness, funniness and helpfulness regarding the counter party at a rating section 612. The user can also block the counter party from future connections by selecting a radio button 623 or add the counter party to my-favorite by selecting a radio button 627. Then the user can tap a “submit” button to save the feedback in the database of the communication application. Alternatively, the user can tap a “decline” button to skip the feedback.

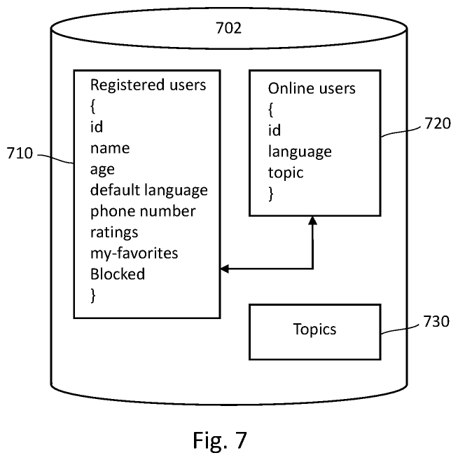

FIG. 7 is a block diagram of a data storage device 702 associated with the communication application of the present disclosure. The data storage device 702 stores a plurality of data repositories 710, 720 and 730 each having a unique data structure. The data repositories 710, 720 and 730 store registered user, online user and topic data, respectively. In embodiment, the registered user data repository 710 stores registered users' name, age, default language, phone number, ratings, my-favorite persons, and blocked persons along with a unique identification associated therewith. The online user data repository 720 stores currently online users' identification, selected language and selected topic. The online user's identification is identical to the registered user's identification so that the two data repositories 710 and 720 can be linked. When a first online user is requesting a second online user for a communication connection, the communication application uses the second user's identification to retrieve the second user's phone number from the registered user data repository 710 to initiate a phone call. The topic data repository 730 stores currently available topics for users to choose from.

The communication application manages the data storage device 702. In embodiments, when a smartphone registers with the communication application, the registered user's information, such as user's name, age, default language, phone number, will be stored in the registered user data repository 710. The After a communication session, the communication application may receive feedback information from a corresponding user, then it computes ratings and/or updates my-favorites and blocked entries in the registered user data repository 710. When the communication application receives an online submission by a smartphone of a pre-registered user, it will enter the smartphone and its associated user's identification, preferred language, and topic information into the online user data repository 720. The communication application in each online smartphone retrieves and displays information of all the other online smartphones that have the common preferences. The communication application also enters new topics into topic data repository 730. The communication application in a logged-in smartphone retrieves the latest collection of topics from the topic data repository 730 for its user to choose from.

Although the disclosure is illustrated and described herein as embodied in one or more specific examples, it is nevertheless not intended to be limited to the details shown, since various modifications and structural changes may be made therein without departing from the spirit of the disclosure and within the scope and range of equivalents of the claims. Accordingly, it is appropriate that the appended claims be construed broadly and in a manner consistent with the scope of the disclosure, as set forth in the following claims.

What is claimed is:

1. A method for establishing a one-to-one voice call between two selected smartphones, the method comprising the sequential steps of:
Receiving predetermined preference data and an indication of ready for internet telephony call by a data storage device from a first smartphone;
retrieving from the data storage device a list of smartphones each having the same predetermined preference data and being ready for internet telephony call, the list of smartphones including feature data of a second smartphone;
displaying the list of smartphones on the first smartphone;
alerting a request for an internet telephony call on the second smartphone when the second smartphone is selected on the first smartphone; and
establishing an internet telephony call between the first and the second smartphone when the request is accepted on the second smartphone.

2. The method of claim 1, wherein the predetermined preference data includes a language for being used in the internet telephony call.

3. The method of claim 1, wherein the predetermined preference data includes a topic of interest preferred by both the first and the second smartphone users.

4. The method of claim 1 further comprising a step of storing the predetermined preference data in a first data structure in the data storage device after receiving the same and before the retrieving step, the first data structure only storing preference data of smartphones that have submitted an indication of ready for internet telephony call.

5. The method of claim 4, wherein the retrieving step includes sorting through data stored in the first data structure to collect the list of smartphones and using an identification of each smartphone in the list to retrieve corresponding feature data from a second data structure.

6. The method of claim 1, wherein the feature data includes name, age and ratings of a user and a phone number of the second smartphone.

7. The method of claim 6 further comprising updating the ratings after an end of the internet telephony call.

8. The method of claim 1, wherein the alerting includes displaying feature data of the first smartphone on the second smartphone.

9. The method of claim 1, wherein the internet telephony call is made using Voice-over-IP protocol.

10. The method of claim 1, wherein the internet telephony call is anonymous.

11. A system for establishing a one-to-one voice call between two selected smartphones, the system comprising:
a first smartphone programed to perform the steps of:
transmitting predetermined preference data and an indication of ready for internet telephony call to a central server;
retrieving a list of smartphones sharing the same predetermined preference data from the central server;
transmitting a request for an internet telephony call to a second smartphone in the list of smartphones; and
establishing a one-to-one internet telephony call with the second smartphone once the request is accepted by the second smartphone; and
a data storage device associated with the central server having a first data structure configured to only store all the smartphones indicated to be ready for internet telephony call, the data storage device retrieving the list of smartphones from the first data structure in response to an instruction from the first smartphone.

12. The system of claim 11, wherein the predetermined preference data includes a language for being used in the internet telephony call.

13. The system of claim 11, wherein the predetermined preference data includes a topic of interest preferred by both the first and the second smartphone users.

14. The system of claim 11, wherein the data storage device includes a second data structure configured to store feature data of pre-registered smartphones, wherein each pre-registered smartphone has a unique identification used to link the first data structure and the second data structure.

15. The system of claim 14, wherein the feature data includes name, age and ratings of a user and a phone number of each pre-registered smartphone.

16. The system of claim 15, wherein the rating is updated after an end of the internet telephony call.

17. The system of claim 11, wherein the list of smartphones includes feature data of each of the smartphones.

18. The system of claim 11, wherein the request for an internet telephony call includes feature data of the first smartphone.

19. A method for establishing a one-to-one voice call between two selected smartphones, the method comprising the sequential steps of:
receiving predetermined preference data and an indication of ready for internet telephony call by a data storage device from a first smartphone;
storing the predetermined preference data in a first data structure in the data storage device, the first data structure only storing preference data of smartphones that have submitted an indication of ready for internet telephony call;
retrieving from the first data structure a list of smartphones each having the same predetermined preference data, the list of smartphones including feature data of a second smartphone;
displaying the list of smartphones on the first smartphone;
alerting a request for an internet telephony call on the second smartphone when the second smartphone is selected on the first smartphone; and
establishing an internet telephony call between the first and the second smartphone when the request is accepted on the second smartphone.

20. The method of claim 1, wherein the predetermined preference data includes a language for being used in the internet telephony call and a topic of interest preferred by both the first and the second smartphone users.
